(19) United States
(12) Patent Application Publication
(10) Pub. No.: US 2019/0042314 A1
(43) Pub. Date: Feb. 7, 2019

(54) RESOURCE ALLOCATION

(71) Applicant: Intel Corporation, Santa Clara, CA (US)

(72) Inventors: Timothy Verrall, Pleasant Hill, CA (US); John J. Browne, Limerick (IE); Tomasz Kantecki, Ennis (IE); Maryam Tahhan, Limerick City (IE); Eoin Walsh, Limerick (IE); Andrew Duignan, Ennis (IE); Alan Carey, Mayo (IE); Wojciech Andralojc, Drawsko (PL); Damien Power, Clare (IE); Tarun Viswanathan, El Dorado Hills, CA (US)

(73) Assignee: Intel Corporation, Santa Clara, CA (US)

(21) Appl. No.: 15/869,909

(22) Filed: Jan. 12, 2018

(51) Int. Cl. G06F 9/50; G06F 9/48

(52) U.S. Cl. CPC G06F 9/5038; G06F 9/5061; G06F 9/4881

(57) ABSTRACT

Particular embodiments described herein provide for an electronic device that can be configured to partition a resource into a plurality of partitions and allocate a reserved portion and a corresponding burst portion in each of the plurality of partitions. Each of the allocated reserved portions and corresponding burst portions are reserved for a specific component or application, where any part of the allocated burst portion not being used by the specific component or application can be used by other components and/or applications.

### BACKGROUND

Emerging network trends in data centers and cloud systems place increasing performance demands on a system. The increasing demands can cause an increase of the use of resources in the system. The resources have a finite capability and access and sharing of the resources needs to be managed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram of a system to enable resource allocation, in accordance with an embodiment of the present disclosure;

FIG. 2 is a block diagram of a portion of a system to enable resource allocation, in accordance with an embodiment of the present disclosure;

FIG. 3 is a block diagram of a portion of a system to enable resource allocation, in accordance with an embodiment of the present disclosure;

FIG. 4 is a block diagram of a portion of a system to enable resource allocation, in accordance with an embodiment of the present disclosure;

FIG. 5 is a table illustrating example details of resource allocation, in accordance with an embodiment of the present disclosure;

FIG. 6 is a flowchart illustrating potential operations that may be associated with the system in accordance with an embodiment;

FIG. 7 is a flowchart illustrating potential operations that may be associated with the system in accordance with an embodiment;

FIG. 8 is a flowchart illustrating potential operations that may be associated with the system in accordance with an embodiment;

FIG. 9 is a flowchart illustrating potential operations that may be associated with the system in accordance with an embodiment; and

FIG. 10 is a flowchart illustrating potential operations that may be associated with the system in accordance with an embodiment.

The FIGURES of the drawings are not necessarily drawn to scale, as their dimensions can be varied considerably without departing from the scope of the present disclosure.

### DETAILED DESCRIPTION

### Example Embodiments

The following detailed description sets forth examples of apparatuses, methods, and systems relating to a system for enabling, resource allocation in accordance with an embodiment of the present disclosure. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

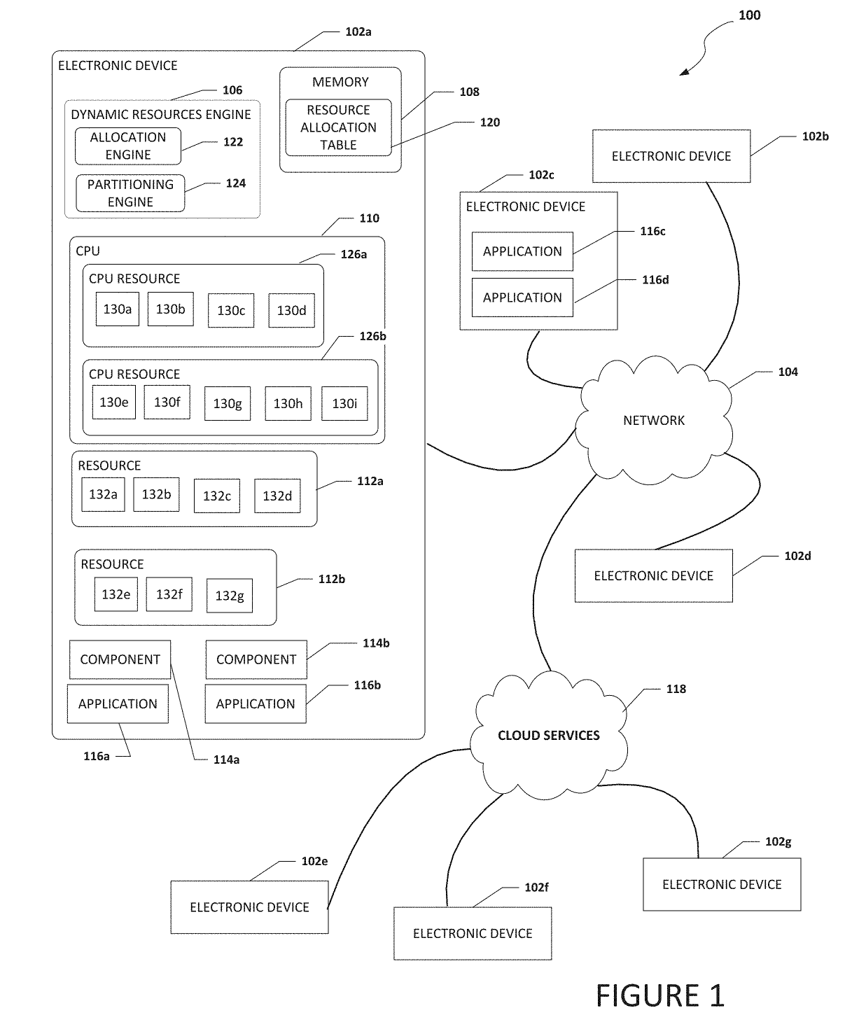

FIG. 1 is a simplified block diagram of an electronic device configured to enable resource allocation, in accordance with an embodiment of the present disclosure. In an example, a system 100 can include one or more electronic devices 102a-102d. Electronic device 102a-102d can be in communication with each other using network 104. In an example, electronic devices 102a-102d and network 104 are part of a data center.

Electronic device 102a can include a dynamic resources engine 106, memory 108, computer processing unit (CPU) 110, a plurality of resources 112a and 112b, a plurality of components 114a and 114b, and one or more applications 116a and 116b. Dynamic resources engine 106 can include a resource allocation engine 122 and a resource partitioning engine 124. Memory 108 can include a resource allocation table 120. CPU 110 can include one or more CPU resources 126a and 126b. In an example, CPU resource 126a may be a cache and CPU resource 126b may be memory bandwidth. Each CPU resource 126a and 126b can be divided into a plurality of partitions. For example, CPU resource 126a can be divided into a plurality of CPU partitions 130a-130d. CPU resource 126b can be divided into a plurality of CPU partitions 130e-130i. Each of resources 112a and 112b can also be divided into a plurality of resources partitions. For example, resource 112a can be divided into resources partitions 132a-132d and resources 112b can be divided into resource partitions 132e-132g.

Each of resources 112a and 112b can be a cache, memory, storage, power, host platform resource, accelerator resource, FPGA resource, PCH resource, or some other resource that may be used by a component (e.g., component 114a) or an application (e.g., application 116a). Each of CPU resources 126a and 126b can be a cache, memory bandwidth, processing thread, CPU core, or some other CPU resource that may be used by a component (e.g., component 114a) or application (e.g., application 116a).

Each component 114a and 114b may be a critical component such as a Host Linux OS, networking stack/IO, virtual switch, hypervisor, management agent, SDN agent, authentication, authorization, and accounting (AAA) component, etc. The term “critical component” includes components (both real and virtual) that are critical or necessary to the execution of an application or process. Each application 116a and 116b may be a, process, function, network virtual function (NVF), etc.

Electronic device 102b can include one or more applications 116c and 116d. Each of electronic devices 102b and 102c can include similar elements (e.g., dynamic resources engine 106, memory 108, CPU 110, plurality of resources 112a and 112b, plurality of components 114a and 114b, one or more applications 116a and 116b, etc.) as electronic device 102a. In an example, one or more electronic devices 102e-120g and cloud services 118 may be in communication with network 104.

In an example, using resource partitioning engine 124, dynamic resources engine 106 can be configured to divide CPU resources (e.g., CPU resource 126a and 126b) and other resources (e.g., resources 112a and 112b) in partitions (e.g., CPU partitions 130a-130d, resources partitions 132a-132d, etc.). Using resource allocation engine 122, dynamic resources engine 106 can assign a particular partition to a component (e.g., component 114a) or an application (e.g., application 116a). Each partition can include a reserved portion and a burst portion. The reserved portion of the resource is a guaranteed region of the resource that is specifically allocated for the component or application. The burst portion of the resource is also a guaranteed amount of the resource specifically allocated for the component or application but if the component or application is not using the allocated burst portion, another component or application can use the burst portion. Dynamic resources engine 106 can enforce the use of the reserved portion and the burst portion.

This allows resources to be allocated for components and applications and for a portion of the allocated resource to be available for other components and applications. More specifically, the reserved portion of the resource helps to ensure that a component or application will always get a guaranteed amount of the resource. The burst portion can help ensure the component or application will have guaranteed additional availability of the resource if needed and when the burst portion is not used by the component or application, the unused burst portion can be used by other components or applications.

In an example, an unused burst portion can be allocated on a first-come-first serve, basis, a round robin basis, a hierarchical basis where one component or application take priority over another component or application, or some other means for allocating the unused burst portion that can help ensure a single component or application is prevented from starving or swamping resources used by other components or applications.

It is to be understood that other embodiments may be utilized and structural changes may be made without departing from the scope of the present disclosure. Substantial flexibility is provided by system 100 in that any suitable arrangements and configuration may be provided without departing from the teachings of the present disclosure. Elements of FIG. 1 may be coupled to one another through one or more interfaces employing any suitable connections (wired or wireless), which provide viable pathways for network (e.g., network 104, etc.) communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

For purposes of illustrating certain example techniques of system 100, the following foundational information may be viewed as a basis from which the present disclosure may be properly explained. End users have more media and communications choices than ever before. A number of prominent technological trends are currently afoot (e.g., more computing devices, more online video services, more Internet traffic), and these trends are changing the media delivery landscape. Data centers serve a large fraction of the Internet content today, including web objects (text, graphics, Uniform Resource Locators (URLs) and scripts), downloadable objects (media files, software, documents), applications (e-commerce, portals), live streaming media, on demand streaming media, and social networks. In addition, devices and systems, such as data centers, are expected to increase performance and function. However, the increase in performance and/or function can cause bottlenecks within the resources of the data center and electronic devices in the data center.

Previous solutions include hardcoding cache and memory bandwidth resources among applications and virtual network functions (VNFs). In an example, upon deployment of a VNF, cache and memory bandwidth may be hardcoded for the VNF. This can present problems because sometimes the hardcoded cache and memory bandwidth is not enough. Other times the hardcoded cache and memory bandwidth is too much and may deprive other applications from using unused hardcoded cache and memory bandwidth. What is needed is a system, method, apparatus, etc. to allow for allocation of resources on the system and can help to prevent a single component or application from starving or swamping resources used by other components or applications.

A device to help with the allocation of resources of a system, as outlined in FIG. 1, can resolve these issues (and others). An electronic device (e.g., electronic device 102a, 102b, and/or 102c) can be configured to divide resources into partitions. Using resource allocation engine 122, dynamic resources engine 106 can assign a particular partition to a component or an application. Each partition can include a reserved portion and a burst portion. The reserved portion of the resource is a guaranteed region of the resource that is specifically allocated for the component or application. The burst portion of the resource is also a guaranteed amount of the resource specifically allocated for the component or application but if the component or application is not using the allocated burst portion, another component or application can use the burst portion. Dynamic resources engine 106 can enforce the use of the reserved portion and the burst portion.

Turning to the infrastructure of FIG. 1, system 100 in accordance with an example embodiment is shown. Generally, system 100 may be implemented in any type or topology of networks. Network 104 represents a series of points or nodes of interconnected communication paths for receiving and transmitting packets of information that propagate through system 100. Network 104 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided in system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102a-102d, are meant to encompass network elements, network appliances, servers, routers, switches, gateways, bridges, load balancers, processors, modules, or any other suitable device, component, element, or object operable to exchange information in a network environment. Electronic devices 102a-102d may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Each of electronic devices 102a-102d may be virtual or include virtual elements.

In regards to the internal structure associated with system 100, each of electronic devices 102a-102d can include memory elements for storing information to be used in the operations outlined herein. Each of electronic devices 102a-102d may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, elements of system 100, such as electronic devices 102a-102d may include software modules (e.g., dynamic resources engine 106, resource allocation engine 122, resource partitioning engine 124, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic devices 102a-102d may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

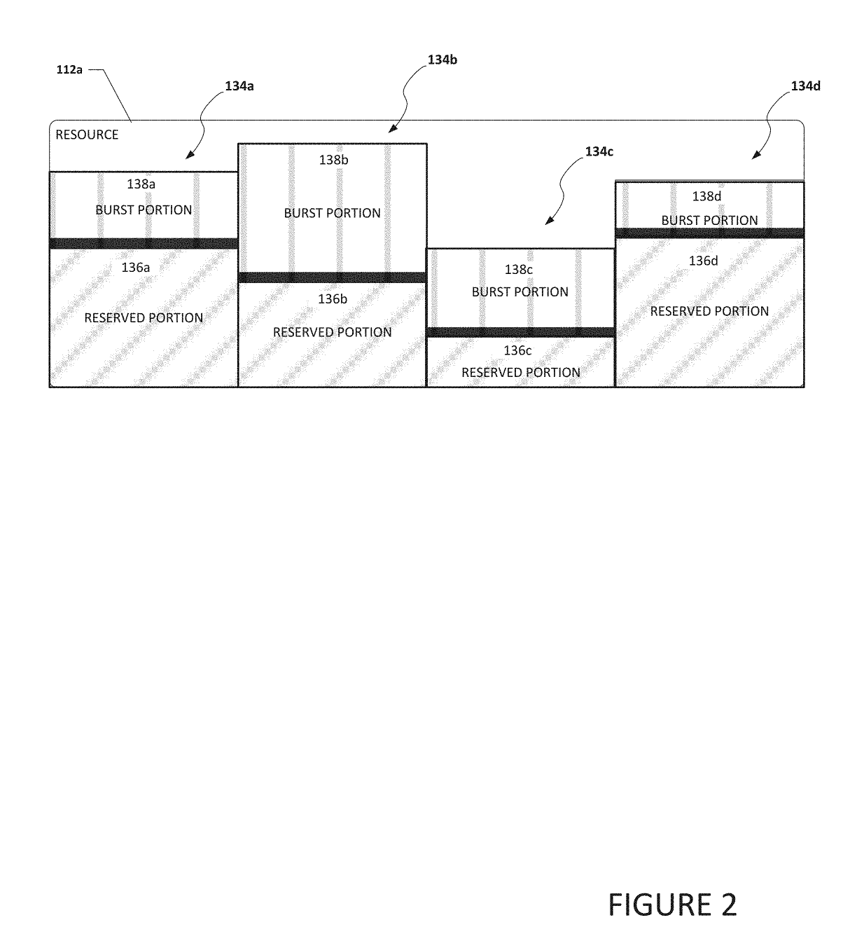

Turning to FIG. 2, FIG. 2 is a simplified block diagram of a portion of electronic device 102a. Resources (e.g., resources 112a and 112b and CPU resources 126a and 126b) can be divided into one or more partitions (e.g., resource 112a can be divided into resource partitions 134a-134d). Each resource partition can be associated with a specific component (e.g., component 114a) or application (e.g., application 116a or 116c). In addition, each resource partition can include a reserved portion and a burst portion. The reserved portion is specifically allocated for use by the component or application associated with the resource partition. The burst portion is also allocated for use by the component or application associated with the resource partition but when the burst portion is not being used by the component or application associated with the resource partition, other components or applications not associated with the resource partition can use the burst portion.

For example, as illustrated in FIG. 2, resource 112a can be divided into resource partitions 134a-134d. Resource partition 134a can be associated with component 114a, resource partition 134b can be associated with component 114b, resource partition 134c can be associated with application 116a, and resource partition 134d can be associated with application 116b. In an example, resource partition 124d can be associated with application 116c on electronic device 102c. Each resource partition 134a-134d can include a reserved portion and a burst portion. For example, resource partition 132a can include reserved portion 136a and burst portion 138a, resource partition 132b can include reserved portion 136b and burst portion 138b, resource partition 132c can include reserved portion 136c and burst portion 138c, and resource partition 132d can include reserved portion 136d and burst portion 138d. During use, only component 114a can use reserved portion 136a. Also, component 114a gets priority over all other components and applications to use burst portion 138a but if component 114a is not using burst portion 138a, then other components and applications can use burst portion 138a.

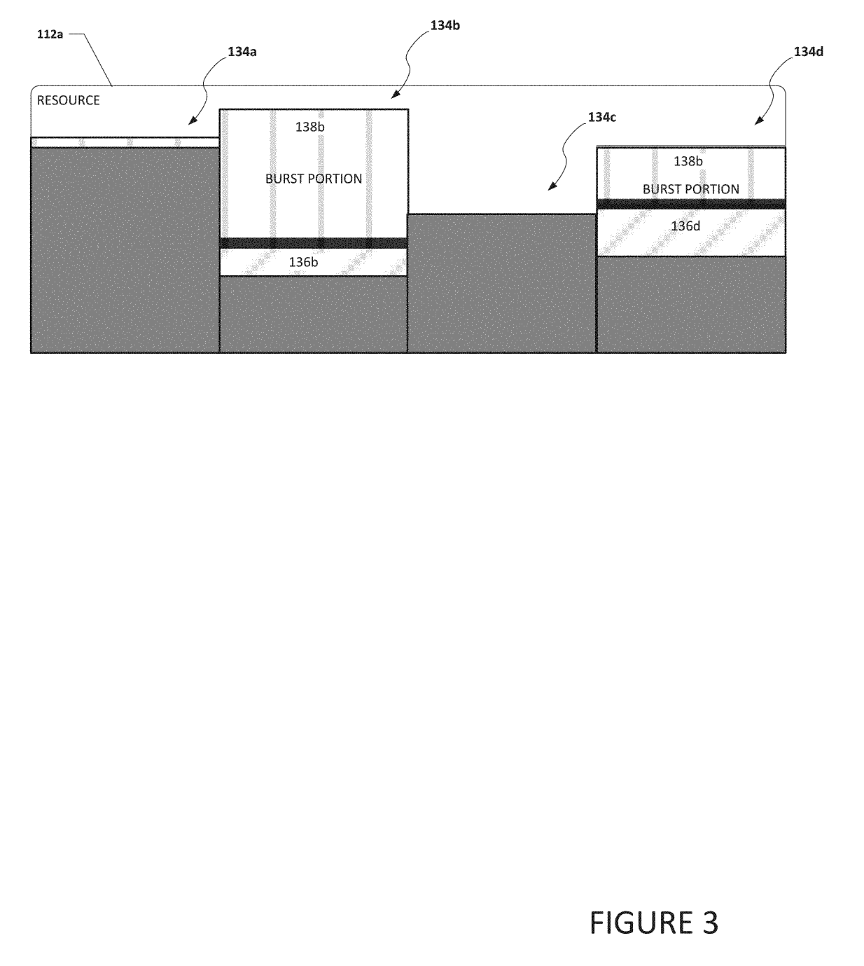

Turning to FIG. 3, FIG. 3 is a simplified block diagram illustrating example details of a portion of electronic device 102a, in accordance with an embodiment of the present disclosure. As explained with reference to FIG. 2, resources (e.g., resources 112a and 112b and CPU resources 126a and 126b) can be divided into one or more partitions (e.g., resource 112a can be divided into resource partitions 134a-134d) and each resource partition can be associated with a specific component or application. For example, resource partition 134a can be associated with component 114a, resource partition 134b can be associated with component 114b, resource partition 134c can be associated with application 116a, and resource partition 134d can be associated with application 116b. Resource partition 132a can include reserved portion 136a and burst portion 138a, resource partition 132b can include reserved portion 136b and burst portion 138b, resource partition 132c can include reserved portion 136c and burst portion 138c, and resource partition 132d can include reserved portion 136d and burst portion 138d.

As illustrated in FIG. 3, component 114a has used all of reserved portion 136a and most of burst portion 138a. Component 114b has used most of reserved portion 136b and none of burst portion 138b. Application 116a has used all of reserved portion 136c and all of burst portion 138c. Application 116b has used some of reserved portion 136d and none of burst portion 138d. In an example, if application 116a needs to use more of resource 112a, application 116a may be able to use burst portion 138b as it is not being used by component 114b or burst portion 138d as it is not being used by application 116b.

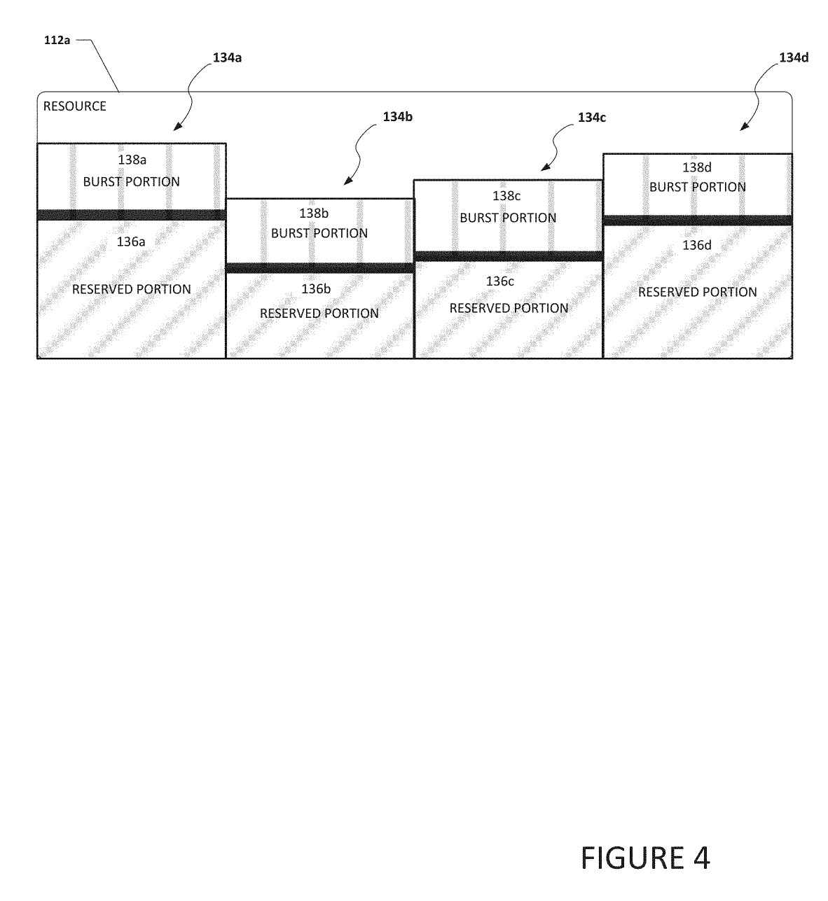

Turning to FIG. 4, FIG. 4 is a simplified block diagram of a portion of electronic device 102a. In an example, resource allocation engine 122 can analyze the usage of each of resource partitions 124a-124d and reallocate the size of each reserved portion and bust portion. For example, as illustrated in FIG. 3, component 114a used all of reserved portion 136a and most of burst portion 138a and resource allocation engine 122 may not cause reserved portion 136a or burst portion 138a to be reallocated. Component 114b used most of reserved portion 136b and none of burst portion 138b and resource allocation engine 122 may not reallocate reserved portion 136b but may reduce the allocated size of burst portion 138b. Application 116a used all of reserved portion 136c and all of burst portion 138c and resource allocation engine 122 may increase the size of reserved portion 136c and/or burst portion 138c. Application 116b used some of reserved portion 136d and none of burst portion 138d and resource allocation engine 122 may decrease the size of reserved portion 136d and/or burst portion 138d.

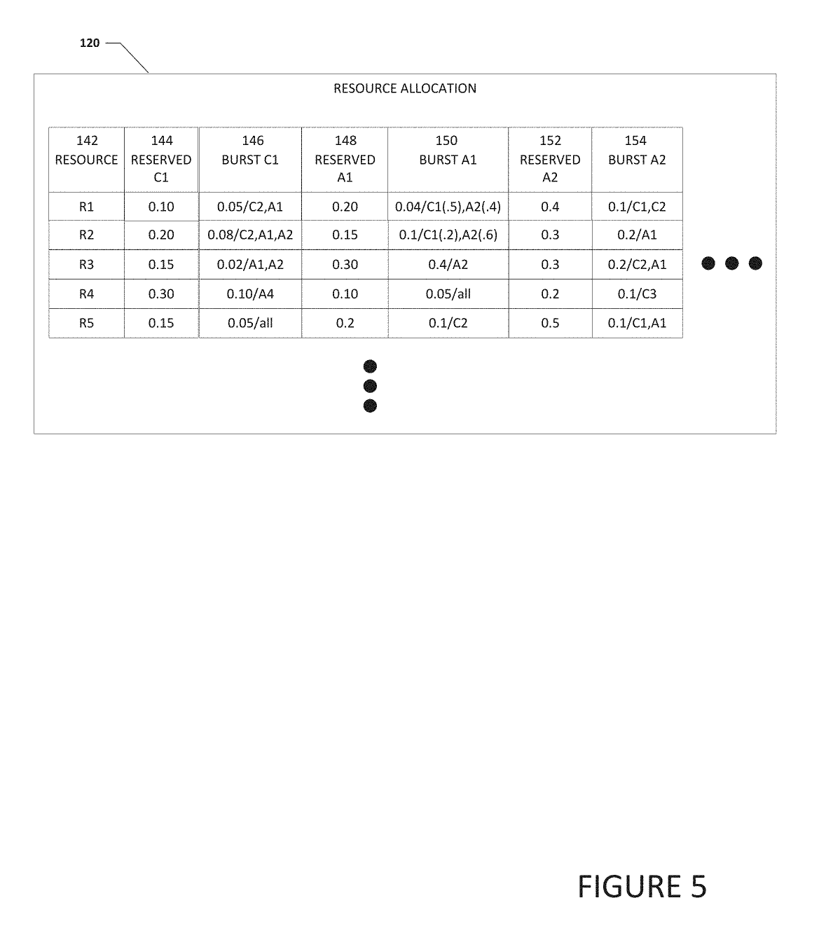

Turning to FIG. 5, FIG. 5 is a simplified block diagram illustrating example details of a resource allocation table 120 for use in system 100, in accordance with an embodiment of the present disclosure. Resource allocation table 120 can include a resource column 142 and a plurality of reserved and burst columns to indicate the allocation of partitions of a particular resource identified in resource column 142. For example, as illustrated in FIG. 5, resource allocation table 120 can include a reserved C1 column 144, a burst C1 column 146, a reserved A1 column 148, a burst A1 column 150, a reserved A2 column 152, and a burst A2 column 154. Resource allocation table 120 can include more resources than those illustrated in resource column 142 and more reserved and burst columns to indicate the allocation of partitions of a particular resource identified in resource column 142.

Each reserved column indicates how a particular partition of a resource is allocated to a component or application. For example, with reference to resource R1 (e.g., CPU resource 126a), C1 (e.g., component 114a) may be allocated a 0.1 (e.g., 10 percent (%)) reserve of resource R1 while A1 (e.g., application 116a) may be allocated a 0.20 (e.g., 20%) reserve of resource R1. Also, C1 may be allocated a 0.05 (e.g., 5%) burst of resource R1 while A1 may be allocated a 0.04 (e.g., 4%) burst of resource R1.

In an example, each burst column (e.g., burst C1 column 146, burst A1 column 150, and burst A2 column 154) can include data that indicates how the burst portion of the partition of the resource is to be shared. More specifically, with respect to resource R2, burst C1 column 146 indicates that the burst portion can be shared by C2 (e.g., component 114b), A1 (e.g., application 116a), and A2 (e.g., application 116b). C2, A1, and A2 may share the burst portion of resource R2 allocated to C1 on a first come first serve basis, a round robin basis, an equally shared basis, or some other method that allows C2, A1, and A2 to share the burst portion of resource R2 allocated to C1. In another specific example, with respect to resource R1, burst A1 column 150 indicates that the burst portion can be shared by C1 and A2 but C1 and A2 can be weighted such that one has priority over the other. For example, as illustrated in FIG. 5, C1 has a weight factor of 0.5 while A2 has a lower weight factor of 0.4 and C1 would have priority over A2 when A1 is not using the burst portion of the resource R1 allocated to A1.

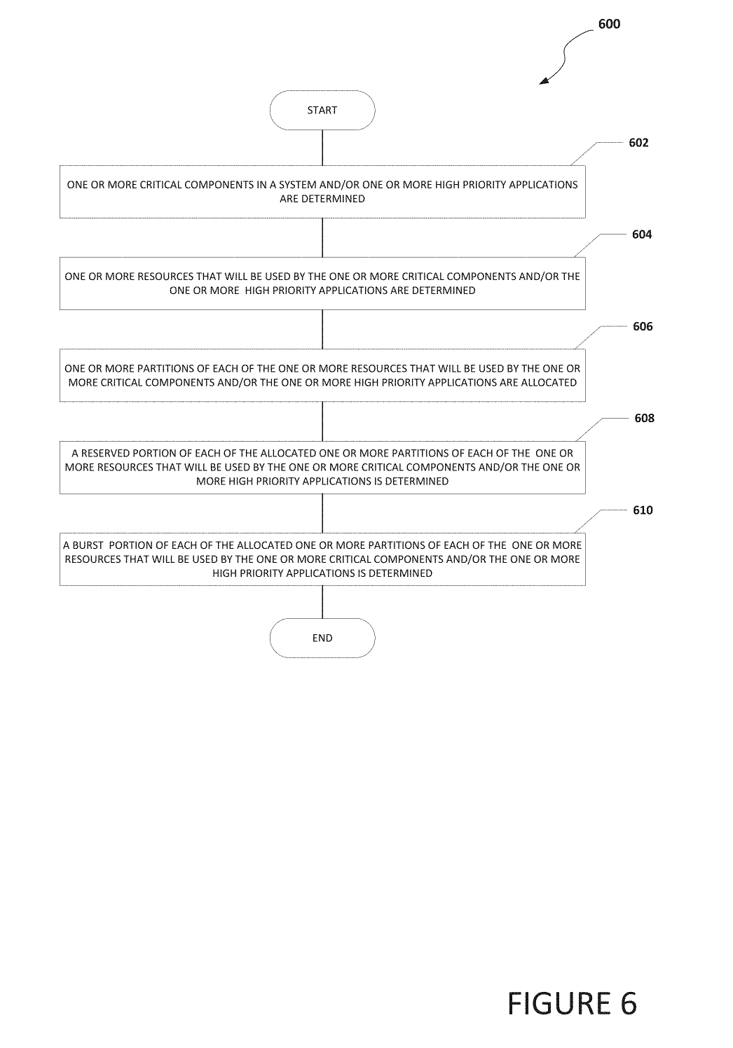

Turning to FIG. 6, FIG. 6 is an example flowchart illustrating possible operations of a flow 600 that may be associated with resource allocation, in accordance with an embodiment. In an embodiment, one or more operations of flow 600 may be performed by dynamic resources engine 106, resource allocation engine 122, and/or resource partitioning engine 124. At 602, one or more critical components in a system and/or one or more high priority applications are determined. At 604, one or more resources that will be used by the one or more critical components and/or the one or more high priority applications are determined. At 606, one or more partitions of each of the one or more resources that will be used by the one or more critical components and/or the one or more high priority applications are allocated. At 608, a reserved portion of each of the allocated one or more partitions of each of the one or more resources that will be used by the one or more critical components and/or the one or more high priority applications is determined. At 610, a burst portion of each of the allocated one or more partitions of each of the one or more resources that will be used by the one or more critical components and/or the one or more high priority applications is determined.

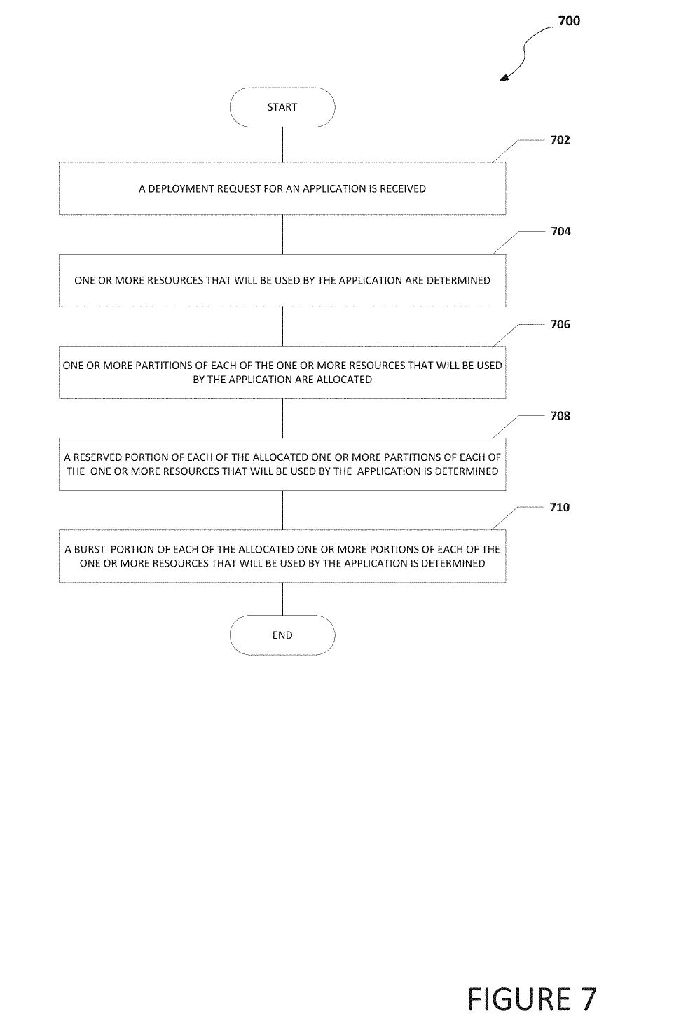

Turning to FIG. 7, FIG. 7 is is an example flowchart illustrating possible operations of a flow 700 that may be associated with resource allocation, in accordance with an embodiment. In an embodiment, one or more operations of flow 700 may be performed by dynamic resources engine 106, resource allocation engine 122, and/or resource partitioning engine 124. At 702, a deployment request for an application is received. At 704, one or more resources that will be used by the application are determined. The application may be on the same device as the one or more resources (e.g., application 116a is on the same electronic device 102a as resource 112a) or the application may be on a different device as the one or more resources (e.g., application 116c is on electronic device 102b while resource 112a is on electronic device 102a). In an example, resource partition 124d can be associated with application 116c on electronic device 102c. At 706, one or more partitions of each of the one or more resources that will be used by the application are allocated. At 708, a reserved portion of each of the allocated one or more partitions of each of the one or more resources that will be used by the application is determined. At 710, a burst portion of each of the allocated one or more partitions of each of the one or more resources that will be used by the application is determined.

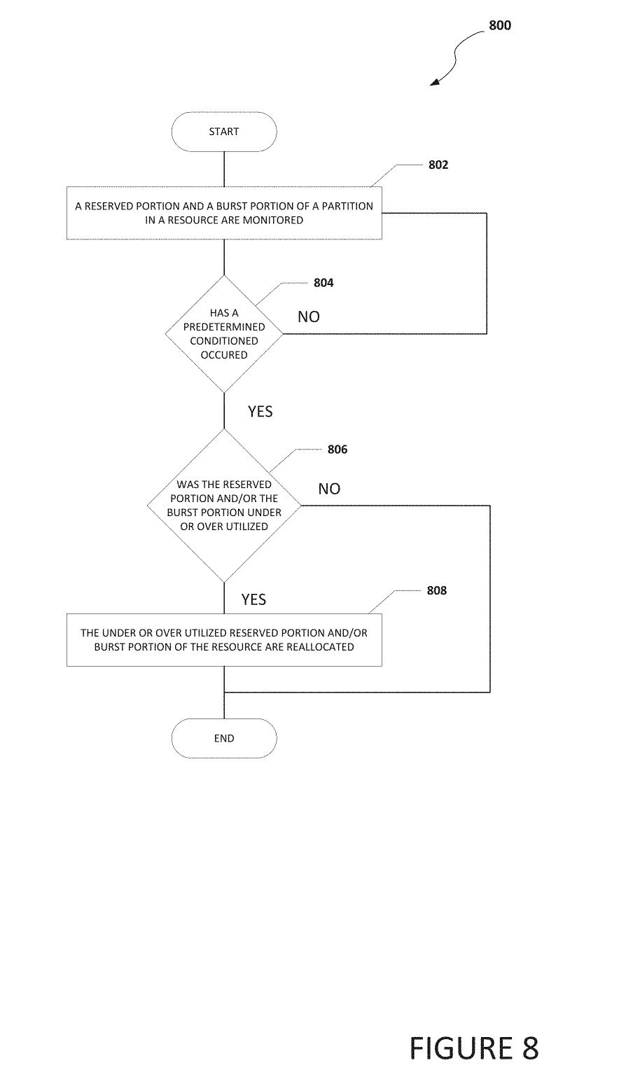

Turning to FIG. 8, FIG. 8 is is an example flowchart illustrating possible operations of a flow 800 that may be associated with resource allocation, in accordance with an embodiment. In an embodiment, one or more operations of flow 800 may be performed by dynamic resources engine 106, resource allocation engine 122, and/or resource partitioning engine 124. At 802, a reserved portion and a burst portion of a partition in a resource are monitored. At 804, the system determines if a predetermined condition has occurred. For example, the predetermined condition may be a specific amount of time, completion of a process, a predetermined amount of data has been process, a CPU has gone through a predetermined amount of calculations, an application, resource, and/or component, was added or removed, etc. lithe predetermined condition has not occurred, then the reserved portion and the burst portion of the partition in the resource continues to be monitored, as in 802.

If the predetermined condition did occur, then the system determines if the reserved portion and/or the burst portion were under or over utilized, as in 806. If the reserved portion and/or the burst portion were under or over utilized, then the under or over utilized reserved portion and/or burst portion of the resource are reallocated, as in 808. If the reserved portion and/or the burst portion were not under or over utilized, then the process ends. In an example, the predetermined condition can be reset and the process can start again at 802 where the reserved portion and the burst portion are monitored.

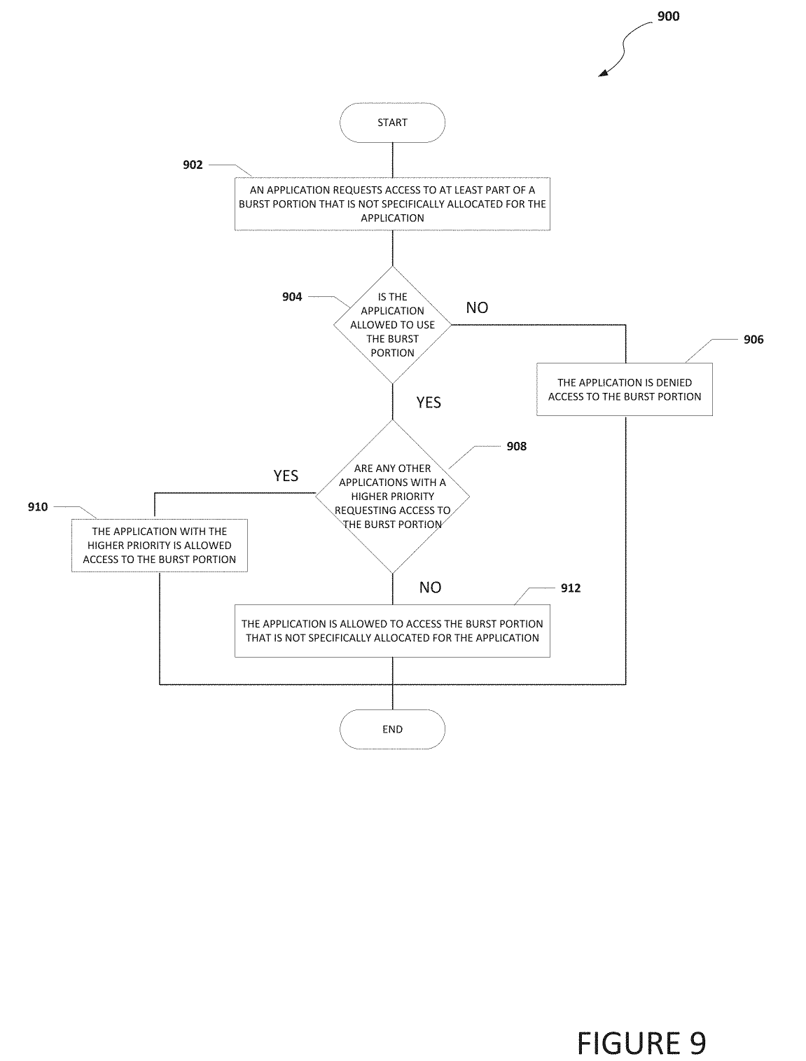

Turning to FIG. 9, FIG. 9 is is an example flowchart illustrating possible operations of a flow 900 that may be associated with resource allocation, in accordance with an embodiment. In an embodiment, one or more operations of flow 900 may be performed by dynamic resources engine 106, resource allocation engine 122, and/or resource partitioning engine 124. At 902, an application requests access to at least part of a burst portion that is not specifically allocated for the application. For example, application 116a (or component 114a) may request access to burst portion 138b that was allocated specifically for component 114b. At 904, the system determines if the application is allowed to use the burst portion. For example, dynamic resources engine 106 can use resource allocation table 120 to determine if application 116a is allowed to use burst portion 138b. If the application is not allowed to use the burst portion, then the application is denied access to the burst portion, as in 906. If the application is allowed to use the burst portion, then the system determines if there are any other applications with a higher priority requesting access to the burst portion, as in 908. For example, dynamic resources engine 106 can use resource allocation table 120 to determine a weight associated with application 116a and if another application or component with a higher weight is attempting to access burst portion 138b. If another application with a higher priority is requesting access to the burst portion, then the application with the higher priority is allowed to access the burst portion as in 910. In an example, the application with the higher priority may not use all of the burst portion and the application can again attempt to access the remaining unused burst portion. If another application with a higher priority is not requesting access to the burst portion, then the application is allowed to access the burst portion that is not specifically allocated for the application, as in 912.

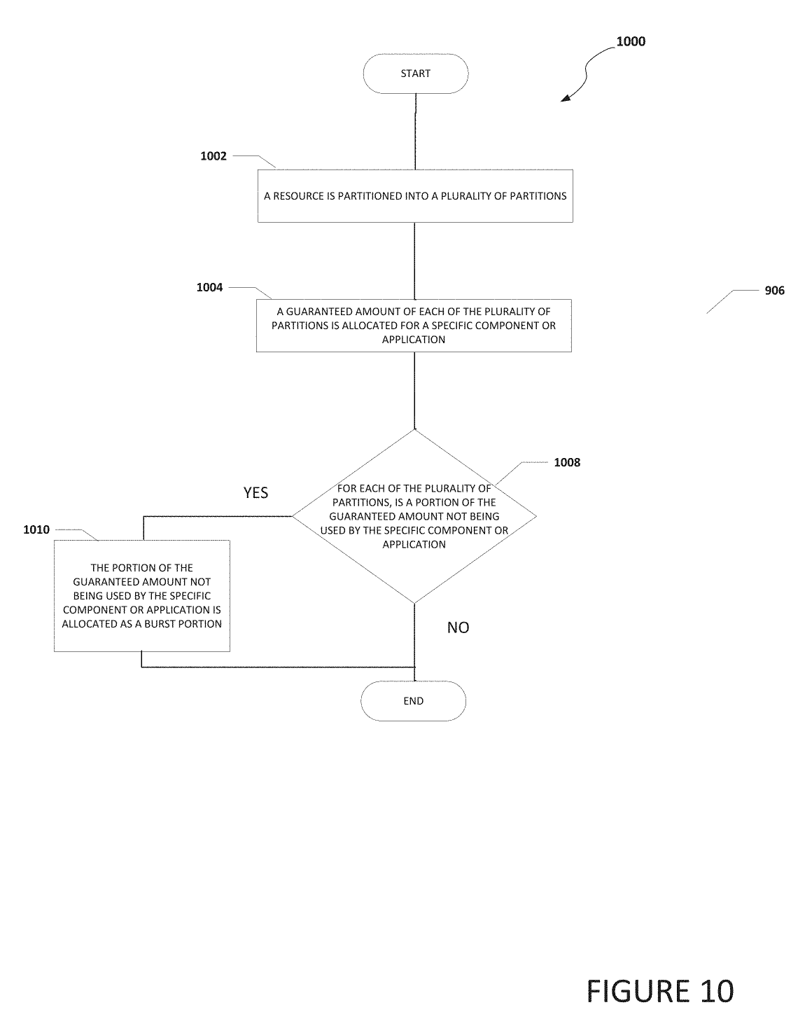

Turning to FIG. 10, FIG. 10 is is an example flowchart illustrating possible operations of a flow 1000 that may be associated with resource allocation, in accordance with an embodiment. In an embodiment, one or more operations of flow 1000 may be performed by dynamic resources engine 106, resource allocation engine 122, and/or resource partitioning engine 124. At 1002, a resource is partitioned into a plurality of partitions. At 1004, a guaranteed amount of each of the plurality of partitions is allocated for a specific component or application. At 1008, for each of the plurality of partitions, the system determines if a portion of the guaranteed amount is not being used by the specific component or application. If a portion of the guaranteed amount is not being used by the specific component or application, then the portion of the guaranteed amount not being used by the specific component or application is allocated as a burst portion, as in 1010.

It is also important to note that the operations in the preceding flow diagrams (i.e., FIGS. 6-10) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 have been illustrated with reference to particular elements and operations that facilitate the communication process, these elements and operations may be replaced by any suitable architecture, protocols, and/or processes that achieve the intended functionality of system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example C1 is at least one machine readable storage medium having one or more instructions that when executed by at least one processor, cause the at least one processor to partition a resource into a plurality of partitions and allocate a guaranteed amount of each of the plurality of partitions for a specific component or application, where a portion of the guaranteed amount not being used by the specific component or application is allocated as a burst portion for use by any other component.

In Example C2, the subject matter of Example C1 can optionally include where the use of the allocated burst portion is shared by the other components and/or applications in a relatively equal manner.

In Example C3, the subject matter of any one of Examples C1-C2 can optionally include where use of the allocated burst portion is shared using a weighted system, where the other components and/or applications are weighted based on priority.

In Example C4, the subject matter of any one of Examples C1-C3 can optionally include where the one or more instructions further cause the at least one processor to reallocate the guaranteed amount of at least a portion of the plurality of partitions.

In Example C5, the subject matter of any one of Examples C1-C4 can optionally include where at least two of the plurality of partitions are not equal in size.

In Example C6, the subject matter of any one of Examples C1-C5 can optionally include where the one or more instructions further cause the at least one processor to prevent at least one of the other components and/or applications from using the allocated burst portion.

In Example C7, the subject matter of any one of Examples C1-C6 can optionally include where the specific component or application is a critical component or critical application.

In Example A1, an electronic device can include memory, a dynamic resources engine, and at least one processor. The at least one processor is configured to cause the dynamic resources engine to partition a resource into a plurality of partitions, allocate a reserved portion and a corresponding burst portion in each of the plurality of partitions, where each of the allocated reserved portions and corresponding burst portions are reserved for a specific component or application, where any part of the allocated burst portion not being used by the specific component or application can be used by other components and/or applications, create a resource allocation table, where the resource allocation table includes a list of the allocated reserved portion and corresponding burst portion for each of the plurality of partitions and store the resource allocation table in the memory.

In Example A2, the subject matter of Example A1 can optionally include where use of the allocated burst portion not being used by the specific component or application is shared by the other components and/or applications in a relatively equal manner.

In Example A3, the subject matter of any one of Examples A1-A2 can optionally include where use of the allocated burst portion not being used by the specific component or application is shared using a weighted system, where the other components and/or applications are weighted based on priority.

In Example A4, the subject matter of any one of Examples A1-A3 can optionally include where the at least one processor is further configured to cause the dynamic resources engine to reallocate at least one of the reserved burst portions.

In Example A5, the subject matter of any one of Examples A1-A4 can optionally include where at least two of the plurality of partitions are not equal in size.

Example M1 is a method including partitioning a resource into a plurality of partitions and allocating a guaranteed amount of r each of the plurality of partitions for a specific component or application, wherein a portion of the guaranteed amount not being used by the specific component or application is allocated as a burst portion for use by any other component.

In Example M2, the subject matter of Example M1 can optionally include where use of the allocated burst portion not being used by the specific component or application is shared by the other components and/or applications in a relatively equal manner.

In Example M3, the subject matter of any one of the Examples M1-M2 can optionally include where use of the allocated burst portion not being used by the specific component or application is shared using a weighted system, where the other components and/or applications are weighted based on priority.

In Example M4, the subject matter of any one of the Examples M1-M3 can optionally include reallocating the guaranteed amount of at least a portion of the plurality of partitions.

In Example M5, the subject matter of any one of the Examples M1-M4 can optionally include where at least two of the plurality of partitions are not equal in size.

In Example M6, the subject matter of any one of Examples M1-M5 can optionally include preventing at least one of the other components and/or applications from using the allocated burst portion.

Example S1 is a system for resource allocation. The system can include memory, one or more processors, and a dynamic resources engine. The dynamic resources engine is configured to partition a resource into a plurality of partitions and allocate a guaranteed amount of each of the plurality of partitions for a specific component or application, wherein a portion of the guaranteed amount not being used by the specific component or application is allocated as a burst portion for use by any other component.

In Example S2 the subject matter of Example S1 can optionally include where use of the allocated burst portion is shared by the other components and/or applications in a relatively equal manner.

In Example S3, the subject matter of any one of the Examples S1-S2 can optionally include where use of the allocated burst portion is shared using a weighted system, where the other components and/or applications are weighted based on priority.

In Example S4, the subject matter of any one of the Examples S1-S3 can optionally include where the dynamic resources engine is further configured to reallocate the guaranteed amount of at least a portion of the plurality of partitions.

In Example S5, the subject matter of any one of the Examples S1-S4 can optionally include where at least two of the plurality of partitions are not equal in size.

In Example S6, the subject matter of any one of the Examples S1-S5 can optionally include where the dynamic resources engine is further configured to create a resource allocation table, where the resource allocation table includes a list of the the guaranteed amount and corresponding burst portion for each of the plurality of partitions and store the resource allocation table in the memory.

In Example S7, the subject matter of any one of the Examples S1-S6 can optionally include where the dynamic resources engine is further configured to prevent at least one of the other components and/or applications from using the allocated burst portion.

Example AA1 is an apparatus including means for partitioning a resource into a plurality of partitions and allocating a reserved portion and a corresponding burst portion in each of the plurality of partitions. Each of the allocated reserved portions and corresponding burst portions are reserved for a specific component or application, where any part of the allocated burst portion not being used by the specific component or application can be used by other components and/or applications.

In Example AA2, the subject matter of Example AA1 can optionally include where use of the allocated burst portion not being used by the specific component or application is shared by the other components and/or applications in a relatively equal manner.

In Example AA3, the subject matter of any one of Examples AA1-AA2 can optionally include use of the allocated burst portion not being used by the specific component or application is shared using a weighted system, where the other components and/or applications are weighted based on priority.

In Example AA4, the subject matter of any one of Examples AA1-AA3 can optionally include means for reallocating at least one of the reserved burst portions.

In Example AA5, the subject matter of any one of Examples AA1-AA4 can optionally include at least two of the plurality of partitions are not equal in size.

In Example AA6, the subject matter of any one of Examples AA1-AA5 can optionally include means for preventing at least one of the other components and/or applications from using the allocated burst portion not being used by the specific component or application.

In Example AA7, the subject matter of any one of Examples AA1-AA6 can optionally include where the specific component or application is a critical component or critical application.

Example X1 is a machine-readable storage medium including machine-readable instructions to implement a method or realize an apparatus as in any one of the Examples A1-A5, AA1-AA8, or M1-M6. Example Y1 is an apparatus comprising means for performing any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that, when executed by at least one processor, causes the at least one processor to:
partition a resource into a plurality of partitions; and
allocate a guaranteed amount of each of the plurality of partitions for a specific component or application, wherein a portion of the guaranteed amount not being used by the specific component or application is allocated as a burst portion for use by any other components and/or applications.

2. The at least one machine readable medium of claim 1, wherein use of the allocated burst portion is shared by the other components and/or applications in a relatively equal manner.

3. The at least one machine readable medium of claim 1, wherein use of the allocated burst portion is shared using a weighted system, wherein the other components and/or applications are weighted based on priority.

4. The at least one machine readable medium of claim 1, wherein the one or more instructions further cause the at least one processor to:
reallocate the guaranteed amount of at least a portion of the plurality of partitions.

5. The at least one machine readable medium of claim 1, wherein at least two of the plurality of partitions are not equal in size.

6. The at least one machine readable medium of claim 1, wherein the one or more instructions further cause the at least one processor to:
prevent at least one of the other components and/or applications from using the allocated burst portion.

7. The at least one machine readable medium of claim 1, wherein the specific component or application is a critical component or critical application.

8. An electronic device comprising:
memory;
a dynamic resources engine; and
at least one processor, wherein the at least one processor is configured to cause the dynamic resources engine to:
partition a resource into a plurality of partitions;
allocate a reserved portion and a corresponding burst portion in each of the plurality of partitions, wherein each of the allocated reserved portions and corresponding burst portions are reserved for a specific component or application, wherein any part of the allocated burst portion not being used by the specific component or application can be used by other components and/or applications;
create a resource allocation table, wherein the resource allocation table includes a list of the allocated reserved portion and corresponding burst portion for each of the plurality of partitions; and
store the resource allocation table in the memory.

9. The electronic device of claim 8, wherein use of the allocated burst portion not being used by the specific component or application is shared by the other components and/or applications in a relatively equal manner.

10. The electronic device of claim 8, wherein use of the allocated burst portion not being used by the specific component or application is shared using a weighted system, wherein the other components and/or applications are weighted based on priority.

11. The electronic device of claim 8, wherein the at least one processor is further configured to cause the dynamic resources engine to:
reallocate at least one of the reserved burst portions.

12. The electronic device of claim 8, wherein at least two of the plurality of partitions are not equal in size.

13. A method comprising:
partitioning a resource into a plurality of partitions; and
allocating a guaranteed amount of each of the plurality of partitions for a specific component or application, wherein a portion of the guaranteed amount not being used by the specific component or application is allocated as a burst portion for use by any other components and/or applications.

14. The method of claim 13, wherein use of the allocated burst portion is shared by the other components and/or applications in a relatively equal manner.

15. The method of claim 13, wherein use of the allocated burst portion is shared using a weighted system, wherein the other components and/or applications are weighted based on priority.

16. The method of claim 13, further comprising:
reallocating the guaranteed amount of at least a portion of the plurality of partitions.

17. The method of claim 13, wherein at least two of the plurality of partitions are not equal in size.

18. The method of claim 13, further comprising:
preventing at least one of the other components and/or applications from using the allocated burst portion.

19. A system for resource allocation, the system comprising:
memory;
one or more processors; and
a dynamic resources engine, wherein the dynamic resources engine is configured to:
partition a resource into a plurality of partitions; and
allocate a guaranteed amount of each of the plurality of partitions for a specific component or application, wherein a portion of the guaranteed amount not being used by the specific component or application is allocated as a burst portion for use by any other components and/or applications.

20. The system of claim 19, wherein use of the allocated burst portion is shared by the other components and/or applications in a relatively equal manner.

21. The system of claim 19, wherein use of the allocated burst is shared using a weighted system, wherein the other components and/or applications are weighted based on priority.

22. The system of claim 19, wherein the dynamic resources engine is further configured to:
reallocate the guaranteed amount of at least a portion of the plurality of partitions.

23. The system of claim 19, wherein at least two of the plurality of partitions are not equal in size.

24. The system of claim 19, wherein the dynamic resources engine is further configured to:
create a resource allocation table, wherein the resource allocation table includes a list of the guaranteed amount and corresponding burst portion for each of the plurality of partitions; and
store the resource allocation table in the memory.

25. The system of claim 19, wherein the dynamic resources engine is further configured to:
prevent at least one of the other components and/or applications from using the allocated burst portion.
